(19) United States
(12) Patent Application Publication
(10) Pub. No.: US 2007/0028779 A1
(43) Pub. Date: Feb. 8, 2007

(54) FOLDABLE BEVERAGE PRESS PLUNGER SYSTEM

(76) Inventors: Anthony Pigliacampo, Menlo Park, CA (US); Aaron Henningsgaard, Palo Alto, CA (US); Alex Grishaver, Daly City, CA (US)

Correspondence Address: LAW OFFICE OF JAMES TROSINO, 92 NATOMA STREET, SUITE 211, SAN FRANCISCO, CA, 94105, US

(21) Appl. No.: 11/462,132

(22) Filed: Aug. 3, 2006

Related U.S. Application Data
(60) Provisional application No. 60/706,556, filed on Aug. 8, 2005.

(51) Int. Cl. A47J 31/20

(52) U.S. Cl. 99/297

(57) ABSTRACT

A foldable beverage press plunger system is provided that includes a shaft and a plunger pivotally attached to an end of the shaft. The plunger may be selectively folded and unfolded, such that the plunger has a first width when the plunger is unfolded, and has a second width smaller than the first width when the plunger is folded. The second width may be sufficiently small that the plunger may be inserted into and removed from the mouth of a beverage container having a mouth that has a diameter that is smaller than a diameter of a body of the beverage container. A collar may be slidably disposed on the shaft, and the collar may be adapted to secure the plunger in an unfolded configuration after the plunger has been inserted into the mouth of the beverage container.

### REFERENCE TO RELATED APPLICATIONS

This application claims the benefit of U.S. Provisional Application Ser. No. 60/706,556, filed 8 Aug. 2005, the entire contents of which is incorporated by reference herein in its entirety.

### BACKGROUND

Beverage presses, such as coffee and tea presses, have long been used to prepare brewed beverages, such as coffee and tea. In a conventional beverage press, a brewing substance, such as coffee grinds, are placed at the bottom of a cylindrical carafe, typically made of glass, and hot water is then poured into the carafe. A matching lid with a plunger is placed on top of the carafe, and the water and coffee are permitted to steep for a few minutes. The plunger has a mesh filter on one end, and has a peripheral edge that seals against the sidewalls of the carafe. When the beverage has been sufficiently brewed, the plunger is pressed down toward the bottom of the carafe. The brewed beverage may then be poured from the carafe, with the coffee grinds trapped beneath the filter at the bottom of the pot.

Although beverage presses are convenient to use, they are not practical for all purposes. For example, because the carafes are typically made of glass, and are therefore somewhat bulky and fragile, a conventional beverage press is impractical for a camping or backpacking trip. Thus, nature lovers and other outdoor enthusiasts who enjoy the taste of brewed beverages are typically forced to make due with instant coffee and tea bags, which often leave much to be desired in terms of taste.

Although a conventional beverage press is not an ideal camping companion, many outdoor enthusiasts often bring beverage containers for water, juice and other similar beverages. In particular, in recent years, wide mouth beverage containers, such as Nalgene bottles manufactured by Nalge Nunc Interantional Corporation, Rochester, N.Y., have become increasingly popular for sport and outdoor use. Such beverage containers are generally cylindrically shaped, made from lightweight plastic, and have a mouth diameter that is smaller than the diameter of the body of the container.

Thus, although such beverage containers are convenient for outdoor use, it is not possible to use such containers with conventional coffee press plungers. In particular, because the peripheral edge of the plunger must form a seal against the sidewalls of the bottle, the plunger needs to be about as large as the body of the bottle to adequately function as a beverage press. However, because the mouth of the bottle has a smaller diameter than the body diameter, a conventional beverage press plunger cannot fit inside the bottle.

In view of the foregoing, it would be desirable to provide a beverage press plunger system that may be used with a beverage container having a mouth opening that has a smaller diameter than the diameter of the body of the container. In particular, it would be desirable to provide a beverage press plunger system that may be used with a wide mouth beverage container, such as a Nalgene bottle.

### SUMMARY

Apparatus in accordance with this invention provide a foldable beverage press plunger system for use with a beverage container, such as a bottle, having a mouth that has a smaller diameter than a diameter of a body of the container. In particular, foldable beverage press plunger systems in accordance with this invention include a shaft and a plunger pivotally attached to an end of the shaft. The plunger may include a filter and a peripheral edge, and may be coupled to the first end of the shaft via a first hinge.

The plunger may be selectively folded and unfolded, such that the plunger has a first width when the plunger is unfolded, and has a second width smaller than the first width when the plunger is folded. The second width may be sufficiently small that the plunger may be inserted into and removed from the mouth of the beverage container.

The plunger may include a center section and two side sections, with each side section pivotally attached to the center section. In particular, the side sections may be coupled to the center sections via second hinges. The center section, side section and second hinges may be integrally formed from a single material.

A collar may be slidably disposed on the shaft, and the collar may be selectively securable to the shaft. In particular, the collar may be adapted to secure the plunger in an unfolded configuration. Thus, after the plunger is inserted into the mouth of the beverage container, the plunger may be unfolded, and the collar may be used to secure the plunger in an unfolded configuration, such that the peripheral edge forms a seal against sidewalls of the body of the beverage container.

A lid may be slidably disposed on the shaft. The lid may include one or more pouring holes, and may be adapted to be securely attached to the mouth of the beverage container. The lid may also be adapted to receive a cap to close the lid. In particular, the lid may be adapted to receive a cap used to close the beverage container.

### BRIEF DESCRIPTION OF THE DRAWINGS

Features of the present invention can be more clearly understood from the following detailed description considered in conjunction with the following drawings, in which the same reference numerals denote the same elements throughout, and in which:

FIG. 1 is a perspective view of an exemplary foldable beverage press plunger system in accordance with this invention;

FIG. 2 is a side view of the exemplary foldable beverage press plunger system of FIG. 1 in an unfolded configuration;

FIG. 3 is a side view of the exemplary foldable beverage press plunger system of FIG. 1 in a folded configuration;

FIG. 4 is another view of the exemplary foldable beverage press plunger system of FIG. 1 in a folded configuration;

FIG. 5 is a side view of the exemplary foldable beverage press plunger system of FIG. 1 in a secured unfolded configuration;

FIG. 6 is a view of the exemplary foldable beverage press plunger system of FIG. 1 being inserted into a bottle;

FIG. 7 is another view of the exemplary foldable beverage press plunger system of FIG. 1 being inserted into a bottle;

FIG. 8 is a side view of the exemplary foldable beverage press plunger system of FIG. 1 inside a beverage container; and

FIG. 9 is another side view of the exemplary foldable beverage press plunger system of FIG. 1 inside a beverage container.

### DETAILED DESCRIPTION

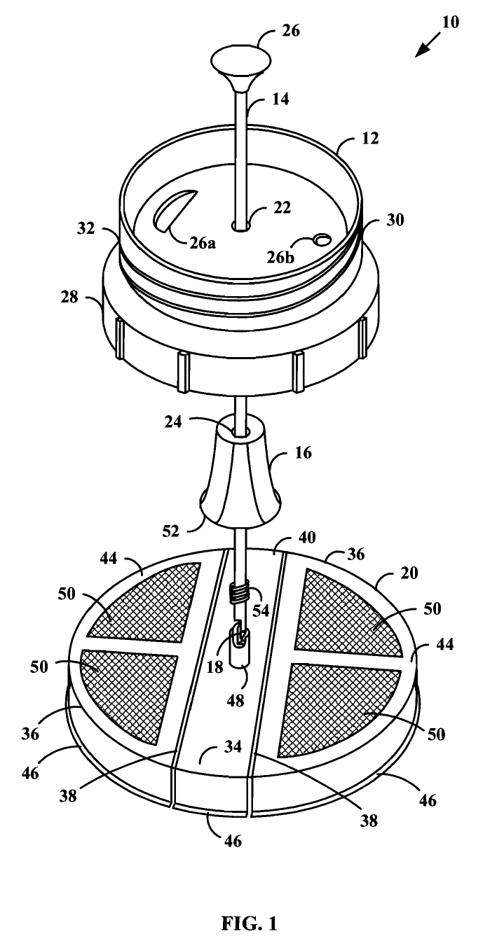

Referring to FIG. 1, an exemplary embodiment of a foldable beverage press plunger system in accordance with this invention is described. Beverage press plunger system 10 includes a lid 12, shaft 14, collar 16, first hinge 18 and plunger 20. Lid 12 and collar 16 are slidably disposed on shaft 14. In particular, lid 12 and collar 16 include apertures 22 and 24, respectively, through which shaft 14 extends. Shaft 14 may be fabricated from plastic, metal, nylon, or other similar material. A handle or knob 26 is disposed at a first end of shaft 14, and plunger 20 is pivotally coupled to a second end of shaft 14 via first hinge 18.

Lid 12 may be fabricated from plastic, metal, nylon, or other similar material, and may include one or more pouring holes 26. Pouring holes may be the same size, or may be different sizes. For example, pouring hole 26a may be larger than pouring hole 26b, and may be used for rapid fluid flow, whereas pouring hole 26b may be used for slower fluid flow. Lid 12 may include a first portion 28 that may be securely attached to a beverage container, such as a bottle (not shown in FIG. 1). Lid 12 also may include a second portion 30 that includes threaded portion 32 adapted to receive a cap or other similar closure mechanism (not shown in FIG. 1).

Plunger 20 includes a center section 34 coupled to side sections 36 via second hinges 38. Center section 34 and side sections 36 may be fabricated from plastic, metal, nylon, or other similar material. Center section 34 and side sections 36 may be distinct sections made from the same material or from different materials. Second hinges 38 may be conventional hinges that may be attached to center section 34 and side sections 36 by screws or other similar attachment means. Alternatively, second hinges 38 may be integrally formed with center section 34 and side sections 36. For example, center section 34, side sections 36 and second hinges 38 may be integrally formed from a single piece of plastic, such as by injection molding or other similar technique. Center section 34 and side sections 36 include top surfaces 40 and 44, respectively, and also include edge 46 extending around the periphery of plunger 20. Center section 34 also includes hub 48 coupled to first hinge 18.

Side sections 36 each include filter portions 50 that allow passage of a liquid, such as water, but that substantially block passage of granulated substances, such as coffee grinds, tea leaves, herbs, spices or other similar brewing substances. Filter portions 50 may be fabricated from stainless steel or other similar material. As illustrated in FIG. 1, each side section 36 includes two separate filter portions 50. Persons of ordinary skill in the art will understand, however, that side sections 36 may include more than or less than two filter portions 50, and may include filter portions having shapes other than those illustrated in FIG. 1.

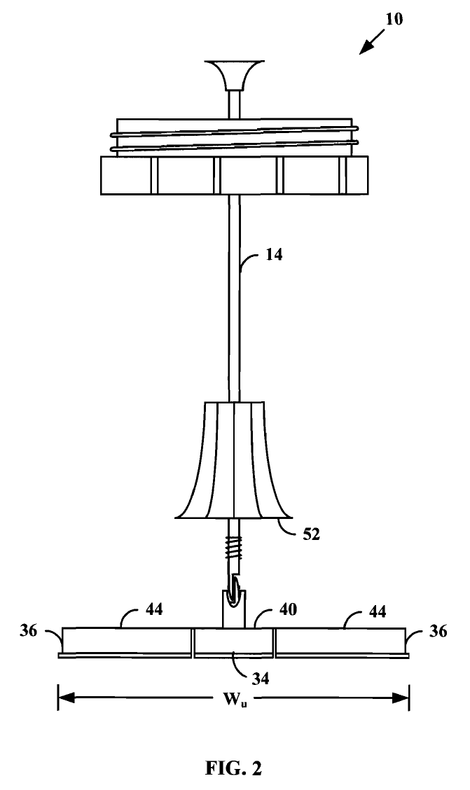

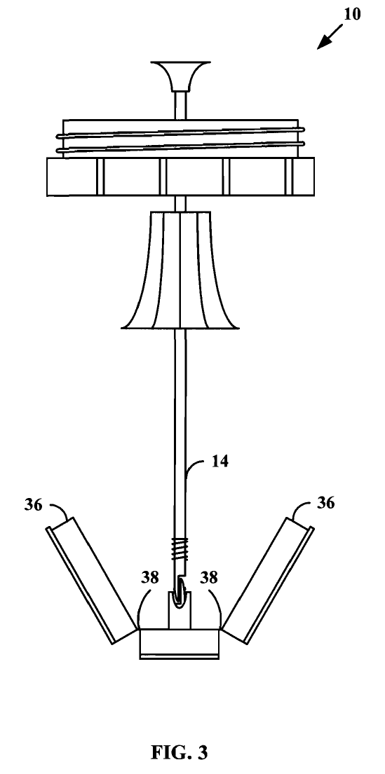

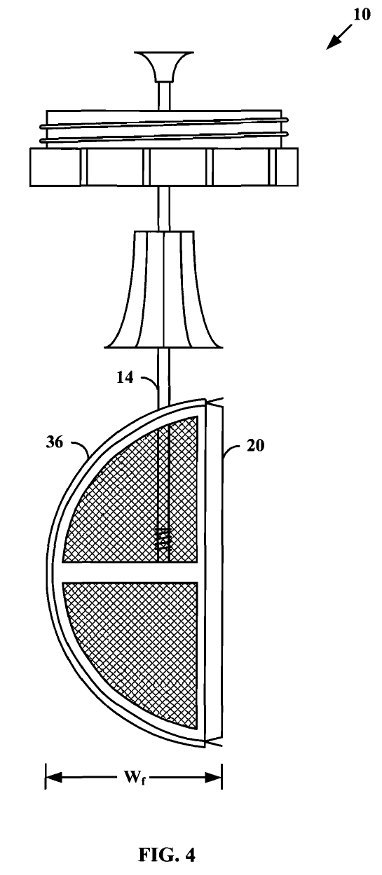

In accordance with this invention, beverage press plunger system 10 may be selectively folded and unfolded. In particular, as illustrated in FIG. 2, in an unfolded configuration, shaft 14 may be disposed substantially perpendicular to top surface 40, and side sections 36 may be disposed such that top surfaces 40 and 44 are substantially coplanar. In an unfolded configuration, plunger 20 has a first width Wᵤ. In contrast, as illustrated in FIGS. 3 and 4, in folded configurations, side sections 36 may be pivoted about second hinges 38 to fold side sections 36 inward toward shaft 14 (FIG. 3), and shaft 14 may be pivoted about first hinge 18 to fold shaft 14 toward either end of center section 34 (FIG. 4). In a folded configuration, plunger 20 has a second width W_{f}, which is smaller than first width Wᵤ. Thus, plunger 20 has a smaller width in the folded configuration than in the unfolded configuration.

As illustrated in FIGS. 2-4, in general, collar 16 may freely slide along shaft 14, shaft 14 may freely pivot about first hinge 18, and side sections 36 may freely pivot about second hinges 38. In accordance with another aspect of this invention, however, collar 16 may be used to selectively secure beverage press plunger system 10 in an unfolded configuration. In particular, in a secured unfolded configuration, collar 16 may be fixedly attached to shaft 14 to prevent shaft 14 from freely pivoting about first hinge 18, and also prevent side sections 30 from freely pivoting about second hinges 32.

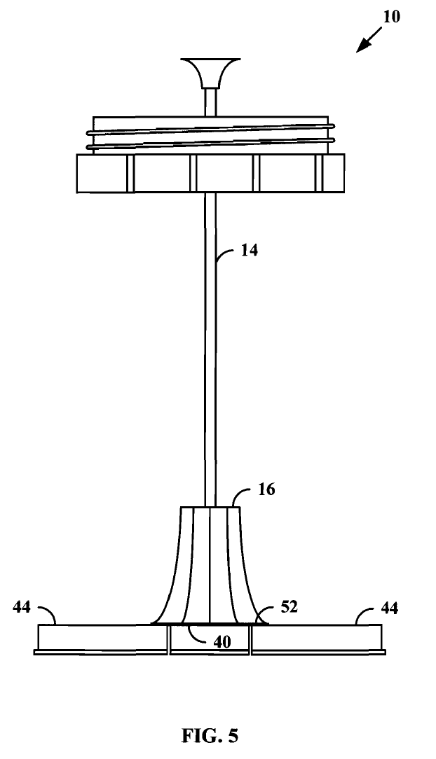

For example, as illustrated in FIG. 5, with side sections 36 folded down so that top surfaces 40 and 44 are substantially coplanar, and with shaft 14 substantially perpendicular to top surface 44, collar 16 may be fixedly attached near second end of shaft 14 so that a bottom surface 52 of collar 16 presses against top surfaces 40 and 44. In this configuration, collar 16 prevents shaft 14 from pivoting about first hinge 18 and also prevents side sections 30 from pivoting about second hinges 32.

To fixedly attach collar 16 to shaft 14, shaft 14 may include threaded portion 54 (FIG. 1), and collar 16 may include an internal threaded portion (not shown), such that collar 16 may be screwed down to tighten bottom surface 52 against top surfaces 40 and 44. Alternatively, shaft 14 and collar 16 may include a snap fitting or other similar attachment means for securing collar 16 on shaft 14 against top surfaces 40 and 44. Collar 16 may be fabricated from plastic, metal, nylon or other similar material. Persons of ordinary skill in the art will understand that collar 16 may have a shape other than that illustrated in FIG. 5. For example, collar 16 may simply be a threaded bolt that may be screwed onto threaded portion 54, such that a bottom surface of the bolt tightens against top surfaces 40 and 44.

In operation, beverage press plunger system 10 may be used with a beverage container, such as a bottle, that has a mouth opening having a smaller diameter than the body of the container. In particular, beverage press plunger system 10 may be disposed in a folded configuration to allow plunger 20 to be inserted into and/or removed from the mouth of the container, and may be disposed in a secured unfolded configuration to permit plunger 20 to function as a beverage press inside the beverage container.

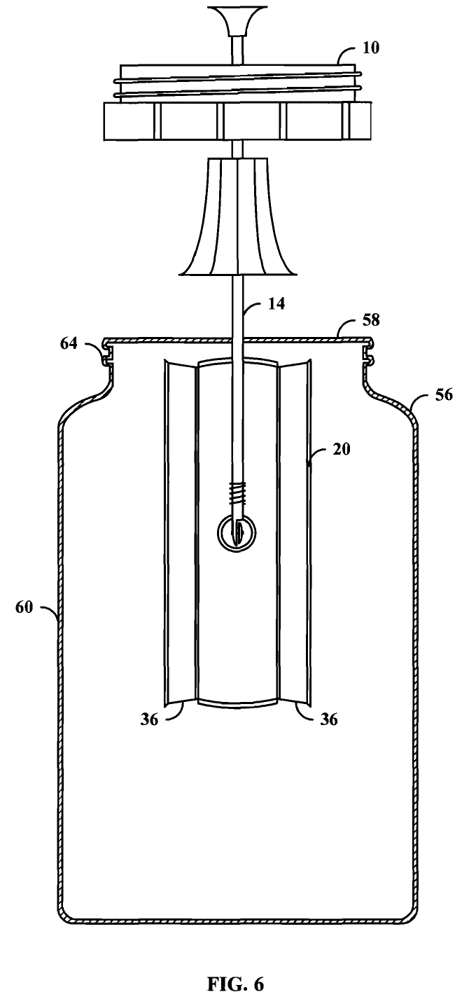

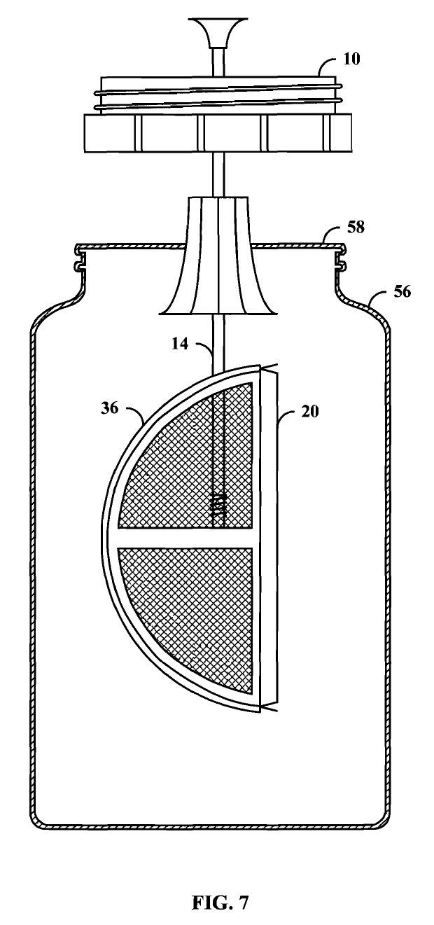

For example, as illustrated in FIGS. 6 and 7, bottle 56 (shown in cross section) has a mouth 58 that has a diameter that is smaller than the diameter of the body 60 of the bottle. After a brewing substance (not shown) has been inserted into bottle 56, plunger 20 may be inserted into the bottle. In particular, side sections 36 may be pivoted about second hinges 38 to fold side sections 36 inward toward shaft 14, and shaft 14 may be pivoted about first hinge 18 to fold shaft 14 toward top end of center section 34, so that plunger 20 may be inserted into mouth 58 of bottle 56.

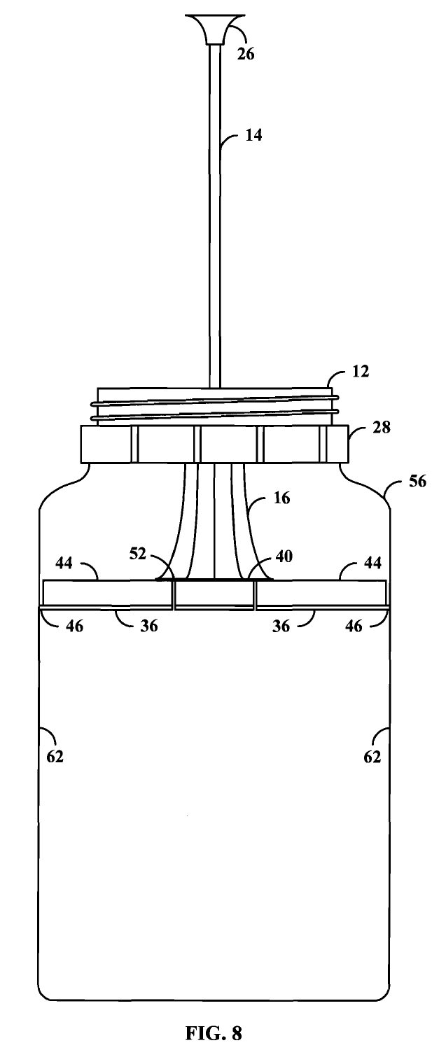

Then, as illustrated in FIG. 8, side sections 36 of plunger 20 may be folded down so that top surfaces 40 and 44 are substantially coplanar, shaft 14 may be positioned substantially perpendicular to top surface 44, and collar 16 may be screwed onto threaded portion 54 of shaft 14 so that bottom surface 52 of collar 16 presses against top surfaces 40 and 44. In this configuration, edge 46 of plunger 20 substantially forms a seal against interior sidewalls 62 of bottle 56. That is, the seal substantially prevents the brewing substance to pass through, but allows the plunger to be raised and lowered inside bottle 56. After pouring a liquid, such as water (not shown), into mouth 58 of bottle 56, lid 12 may be secured to bottle 56. In particular, first portion 28 of lid 12 may include a threaded portion (not shown) that may be screwed onto threaded portion 64 (FIG. 6) of bottle 56. Persons of ordinary skill in the art will understand that first portion 28 alternatively may be secured to bottle 56 via a snap closure or other similar attachment means.

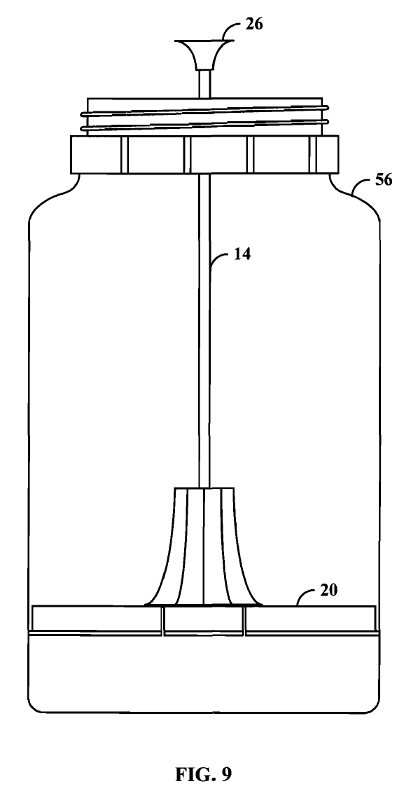

Next, as shown in FIGS. 8 and 9, after allowing the liquid and brewing substance to brew, a user may apply pressure to handle 26 to push shaft 14 and plunger 20 toward the bottom of bottle 56. In this regard, plunger 20 pushes the brewing substance to the bottom of bottle 56, as in a conventional beverage press. The brewed liquid may then be poured from either or both of pouring holes 26 (FIG. 1). In addition, after handle 26 has been fully inserted into lid 12, a cap (not shown) may be screwed onto threaded portion 32 of lid 12. For example, if bottle 56 includes a threaded cap (not shown), threaded portion 32 may be sized so that the bottle cap may be screwed onto threaded portion 32. Persons of ordinary skill in the art will understand that a cap or other similar closure mechanism alternatively may be secured onto lid 12 via a snap closure or other similar attachment means.

To remove plunger 20 from bottle 56, the steps described above with respect to FIGS. 6-8 are reversed. In particular, after removing lid 12 from bottle 56, handle 26 is used to pull plunger up toward the top of the bottle. Collar 16 is unscrewed from threaded portion 54, and collar 16 is slid toward the first end of shaft 14. Side sections 36 may then be pivoted about second hinges 38 to fold side sections 36 inward toward shaft 14, and shaft 14 may be pivoted about first hinge 18 to fold shaft 14 toward top end of center section 34, so that plunger 20 may be removed from mouth 58 of bottle 56.

The foregoing merely illustrates the principles of this invention, and various modifications can be made by persons of ordinary skill in the art without departing from the scope and spirit of this invention. For example, although the exemplary beverage press plunger system 10 in accordance with this invention included a circularly shaped plunger 20, other plunger shapes and configurations alternatively may be used depending on the shape of the beverage container. Thus, for square-shaped, oval-shaped, rectangular-shaped and triangular-shaped beverage containers, corresponding square-shaped, oval-shaped, rectangular-shaped and triangular-shaped plungers 20 may be used. Additionally, although the exemplary beverage press plunger system 10 includes lid 12, such a lid may optionally be omitted. Further, cables, wires, cords or other similar mechanisms may be added to beverage press plunger system 10 to aid in the removal of the device from a beverage container.

1. A beverage press plunger system comprising:
a shaft; and
a plunger pivotally attached to an end of the shaft, the plunger adapted to be selectively folded and unfolded, wherein the plunger has a first width when the plunger is unfolded, and has a second width smaller than the first width when the plunger is folded.

2. The beverage press plunger system of claim 1, wherein the plunger comprises a filter.

3. The beverage press plunger system of claim 1, further comprising a first hinge coupled between the shaft and the plunger.

4. The beverage press plunger system of claim 1, wherein the plunger comprises:
a center section; and
a pair of side sections, each side section pivotally attached to the center section.

5. The beverage press plunger system of claim 4, wherein the center section is integral with the side sections.

6. The beverage press plunger system of claim 4, wherein the center section is distinct from the side sections.

7. The beverage press plunger system of claim 4, further comprising second hinges coupled between the center section and each of the side sections.

8. The beverage press plunger system of claim 7, wherein the second hinges are integral with the center section and side sections.

9. The beverage press plunger system of claim 7, wherein the second hinges are distinct from the center section and side sections.

10. The beverage press plunger system of claim 1, further comprising a collar slidably disposed on the shaft.

11. The beverage press plunger system of claim 10, wherein the collar is selectively securable to the shaft.

12. The beverage press plunger system of claim 10, wherein the collar is adapted to secure the plunger in an unfolded configuration.

13. The beverage press plunger system of claim 1, further comprising a lid slidably disposed on the shaft.

14. The beverage press plunger system of claim 13, wherein the lid comprises a pouring hole.

15. The beverage press plunger system of claim 13, wherein the lid is adapted to be securely attached to a mouth of a beverage container.

16. Apparatus for use with a beverage container comprising a mouth and a body, the mouth having a diameter that is smaller than a diameter of the body, the body having internal sidewalls, the apparatus comprising:
a shaft; and
a plunger pivotally attached to an end of the shaft, the plunger comprising a peripheral edge, wherein the plunger may be selectively folded, such that the plunger may be inserted through the mouth into the beverage container, and unfolded, such that the peripheral edge forms a seal against the sidewalls.

17. The apparatus of claim 16, wherein the plunger comprises a filter.

18. The apparatus of claim 16, further comprising a first hinge coupled between the shaft and the plunger.

19. The apparatus of claim 16, wherein the plunger comprises:
a center section; and
a pair of side sections, each side section pivotally attached to the center section.

20. The apparatus of claim 19, wherein the center section is integral with the side sections.

21. The apparatus of claim 19, wherein the center section is distinct from the side sections.

22. The apparatus of claim 19, further comprising second hinges coupled between the center section and each of the side sections.

23. The apparatus of claim 22, wherein the second hinges are integral with the center section and side sections.

24. The apparatus of claim 22, wherein the second hinges are distinct from the center section and side sections.

25. The apparatus of claim 16, further comprising a collar slidably disposed on the shaft.

26. The apparatus of claim 25, wherein the collar is selectively securable to the shaft.

27. The apparatus of claim 25, wherein the collar is adapted to secure the plunger in an unfolded configuration.

28. The apparatus of claim 16, further comprising a lid slidably disposed on the shaft.

29. The apparatus of claim 28, wherein the lid comprises a pouring hole.

30. The apparatus of claim 28, wherein the lid is adapted to be securely attached to the mouth.

31. A beverage system comprising:
a beverage container comprising a mouth having a first diameter; and
a shaft and a plunger pivotally attached to an end of the shaft, the plunger adapted to be selectively folded and unfolded, wherein the plunger has a second diameter when unfolded that is larger than the first diameter, and wherein the plunger may be inserted through the mouth into the beverage container when the plunger is folded.
